(19) United States
(12) Patent Application Publication
(10) Pub. No.: US 2014/0069246 A1
(43) Pub. Date: Mar. 13, 2014

(54) DEVICE FOR SEPARATING MATERIALS WHILE PRODUCING A THIN KERF

(71) Applicant: Stefan Moehringer, Wiesentheid (DE)

(72) Inventor: Stefan Moehringer, Wiesentheid (DE)

(73) Assignee: Simon Moehringer Anlagenbau GmbH, Wiesentheid (DE)

(21) Appl. No.: 14/111,794

(22) PCT Filed: Apr. 20, 2012
(86) PCT No.: PCT/DE2012/100112

§ 371 Date: Oct. 15, 2013

(30) Foreign Application Priority Data
Apr. 20, 2011 (DE) 10 2011 002 209.0

(51) Int. Cl. B27B 13/00; B23D 61/12; B27B 33/06

(52) U.S. Cl. CPC B27B 13/00; B27B 33/06; B23D 61/12
USPC 83/72; 83/661; 83/169; 83/409; 83/820

(57) ABSTRACT

According to prior art, especially wood workpieces are cut by means of band saws or gate saws, a chipping-type separation of the workpiece (5) being achieved by means of the toothing of the saw blades (2). Proceeding from the prior art, the invention relates to a novel device for separating materials (1) wherein an abrasive saw blade (2) of little blade thickness and having a close-toothed microtoothing (3) is used so that a grinding-type separation of materials is achieved. The resulting kerfs are considerably thinner and the cut edges are treated more gently than known from the prior art. The novel abrasive saw blade (2), however, requires more time-consuming blade guidance and blade cleaning and a different blade production. Treatment of wood and veneers.

The invention relates to an apparatus for cutting of materials, producing a thin saw kerf.

Such an apparatus is known from DE 40 11 924 A1, which relates to a band-saw blade. In this apparatus, the thin saw kerf is produced in that the band saw blade narrows from a blade thickness that is otherwise essentially uniform, in the direction toward the tooth tip roots, and that the tooth tip width is not greater than the thickness of the saw blade in the region of the uniform blade thickness. However, because the saw blade must otherwise be guided in the saw kerf, it has proven to be practical to follow the saw blade, in the cutting direction, with a splitting wedge that widens the saw kerf. Furthermore, the splitting wedge must be provided with cooling channels during operation, in order to prevent the apparatus from running hot.

From the state of the art, it is furthermore known to cut wood work pieces and materials to size, in connection with the production of high-quality finished products such as parquet lamellae or flooring, by means of gate saws, circular saws or band saws. In all cases, this involves a form of chip-removing work or chip-removing cutting of materials. In this connection, circular saws conventionally work with cutting depths of approximately 150 mm, while gate saws and band saws work with cutting depths of approximately 300 mm. Within the scope of the known cutouts, the wood is therefore essentially cut up. The minimal saw kerfs that are possible in this connection lie in the range of approximately 1.4 mm.

These previously known production techniques are certainly subject to disadvantages. In the production of a usual parquet lamella having a thickness of 3 mm, approximately half the material used is used up, i.e. converted to wood waste material in the form of chips and sawdust, within the scope of the previously known cutting method, because of the problem of the significant saw kerf width and the material treatment, which is not exactly gentle. In the case of chip-removing material treatment, there is the risk that tear-outs will occur during processing of the material, for example when sawing branches. The corresponding defects must either be reworked, in complicated manner, or the wood that has been processed must be sorted out as waste. For the same reason, it is also not possible to produce particularly thin lamellae. The previously known production methods demand a lamella thickness of 2 mm and greater. In most cases, such cutting methods cannot be used for high-quality wood types. In every case, very complicated prior and subsequent processing of the treated work pieces, such as steaming of the raw wood in advance of processing and drying and smoothing of the applied veneers subsequent to processing is required. As a rule, special blade machines are used for this purpose.

The cut surfaces, which are furthermore usually very rough, must often be subsequently worked, in complicated manner.

Proceeding from this state of the art, a new type of apparatus for cutting of materials, particularly of woods, is to be developed, in which the consumption of resources is reduced, and furthermore, the prior and subsequent processing effort is also clearly less.

The solution of this task is achieved by means of an apparatus according to the main claim. Advantageous embodiments of the invention can be derived from the dependent claims 2 to 17.

Within the scope of the solution according to the invention, a preferably endless grinding saw blade having a micro-tooth system is used for cutting of materials. The micro-tooth system possesses a comparatively low cutting depth, so that while the cutting of materials takes place in chip-removing manner, the friction wear in the saw kerf produces not so much a chip but rather a saw meal. The significant advantage of the cutting, however, particularly lies in that the saw kerf is clearly reduced in size, because the tooth system is ground alternately, in the cutting direction, on the right side and the left side, to form a micro-blade, and therefore the saw kerf is alternately processed in the cutting direction, in other words simultaneously on the right and the left side, during the same cutting process. This micro-tooth system also makes it possible to work with a saw blade that has a clearly reduced thickness. In the end result, the saw kerf can therefore be configured to be clearly narrower, and the resulting material loss caused by the cutting of materials can be clearly reduced. The cut surface is worked on in clearly finer manner, and in most cases already forms a surface that can be glued, because it is in fact a ground surface, which does not require any further processing for usual applications. Furthermore, lamellae having a thickness from 0.2 mm can be produced, in other words veneers, for example, can be cut with the novel type of apparatus.

In an advantageous further development, the micro-teeth are configured to be alternately slanted, relative to one another, in the cutting direction, so that an offset endless saw blade is formed. As a result, the saw kerf is widened relative to the saw blade, so that sticking of the endless saw blade during operation is precluded.

In a concrete embodiment, the tooth pitch of the micro-tooth system amounts to 0.5 to 2 mm, and the tooth base has a depth of ≦1.5 mm.

In an advantageous embodiment of the invention, the novel type of micro-tooth system of the grinding saw blade is used in combination with a changed cutting angle, so that the micro-tooth system is set, relative to the saw blade, in such a manner that a cutting angle of preferably 40° to 60° relative to the surface of the material to be cut occurs, while in the previously known methods that have been presented in detail, a cutting angle of 90° is usual.

A further contribution to gentle cutting of materials and, in particular, for implementation of thin saw kerfs, consists in that the projection of the tooth blades of the micro-teeth relative to the saw blade amounts to only a few tenths of millimeters, preferably to 1/10 mm. If one proceeds from a saw blade thickness that has also been reduced, of 0.3 mm, a minimal saw kerf having a width of 0.4 mm, which can be implemented with the apparatus according to the invention, in contrast with the state of the art, is obtained with this configuration.

Because of the low saw blade thickness that has already been mentioned, it is practical to connect the saw blade ends for producing an endless saw band in a different way from before, because on the basis of the low material thickness, a conventional weld seam would not withstand the tension forces that occur. The saw blade ends are therefore intermeshed with form fit, at first, in the apparatus according to the invention, whereby a swallowtail tooth system has proven itself in this connection, and subsequently welded to produce material fit. In this connection, a laser welding process is to be preferred, because a connection that is particularly well able to withstand stress must be produced.

In order to allow cutting of materials by means of grinding, to a great extent, very close spacing of the micro-tooth system that has already been mentioned is required. The usual distance between the teeth of the micro-tooth system amounts to less than 1 mm. This also makes new demands on the cleaning of the saw blade that is required during the ongoing process. Conventional band saws are simply vacuumed clean, whereby the sawdust that occurs during cutting of the material is simply drawn away by way of corresponding suction channels after exiting from the saw kerf of the material to be cut. Only a residual amount caused by turbulence and static adherence remains on the processed woods, so that the machine space additionally undergoes basic cleaning at regular intervals. This method is not sufficient for the micro-tooth system that is now being used. In contrast to conventional cutting of materials, instead of sawdust, more of a saw meal or grinding meal is formed. In the narrow tooth system, an overly large proportion of saw meal would remain in the tightly dimensioned tooth base disposed between the teeth, and this would lead to heating of the saw apparatus and finally to destruction of the micro-tooth system during renewed cutting. It has proven itself, in this connection, if instead of the suction channels that have already been mentioned, a blowing apparatus is assigned to the apparatus, in such a manner that the micro-tooth system is impacted by a water/air mixture when it exits from the saw kerf of the material to be cut, in such a manner, and that the adhering saw meal can be reliably removed in this way.

In a further embodiment of the invention, it is furthermore practical if a further blowing apparatus is also disposed on the back of the saw blade, which apparatus also presses a corresponding water/air mixture into the saw kerf, at high pressure, in order to free the latter from the residues of the cutting of materials, which is a grinding process, to a great extent.

In an advantageous embodiment of the invention, the two blowing apparatuses are connected with a common supply unit and/or control unit, so that charging of the blowing apparatuses with the water/air mixture that has already been mentioned and buildup of the pressure can be synchronized and can take place with common units.

In a further embodiment, a collection apparatus for collecting the water/saw meal and wood waste mixture is disposed in the blow-off direction of the water/air mixture applied to the saw blade and to the material to be cut, whereby ideally, a filter element for pre-cleaning follows the collection apparatus in the flow-off direction of the water/saw meal mixture.

In a further improvement of the invention, the work piece guidance must also be adapted to the greater cutting precision implemented with the method and the lower tolerances that can be achieved. In this connection, it has proven itself if a usual wall or chain conveyor additionally has vacuum nozzles assigned to it, in such a manner that the work piece to be processed, in each instance, is fixed in place in the processing plane and subsequently moved relative to the saw blade. By means of the contact pressure that is implemented by means of the vacuum, flat contact of the work piece is ensured even at lower material thicknesses. A corresponding vacuum guidance is very helpful, for example, in the production of veneers.

In a further embodiment, a pivot mechanism is assigned to the roller or chain conveyor, by way of which mechanism it is ensured that the work pieces to be cut are fed to the band saw blade in such a manner that the entry angle of the micro-tooth system into the work piece to be cut is infinitely adjustable in a range from 60° to 90°.

For the case that the saw blade according to the invention, having the micro-tooth system, is structured as an endless band, this endless band is passed over two band saw rollers that are spaced apart from one another, whereby at least one of the band saw rollers is driven.

In this connection, however, the higher production precision that has already been mentioned requires that the relative position of the band saw with regard to the band saw rollers is monitored by means of a sensor system, optically or haptically, and that the inclination of at least one band saw roller can be automatically adjusted as a function of this measurement result, after an actual value/reference value comparison, by means of a corresponding angle adjustment apparatus.

For the remainder, it has proven itself if the forward movement of the saw band is monitored or if the band conveyor is provided with a reverse movement stop. Because of the low saw tooth depth of only a few millimeters, preferably of one millimeter, reverse movement of the saw band by only one millimeter would already damage the mini-tooth in question, in each instance. Accordingly, corresponding safety precautions are required.

In an alternative embodiment, the saw band having the micro-tooth system can also be clamped vertically in a saw frame and used in what is called a saw gate.

The invention will be explained in greater detail below, using an exemplary embodiment that is shown only schematically in the drawing.

This shows:

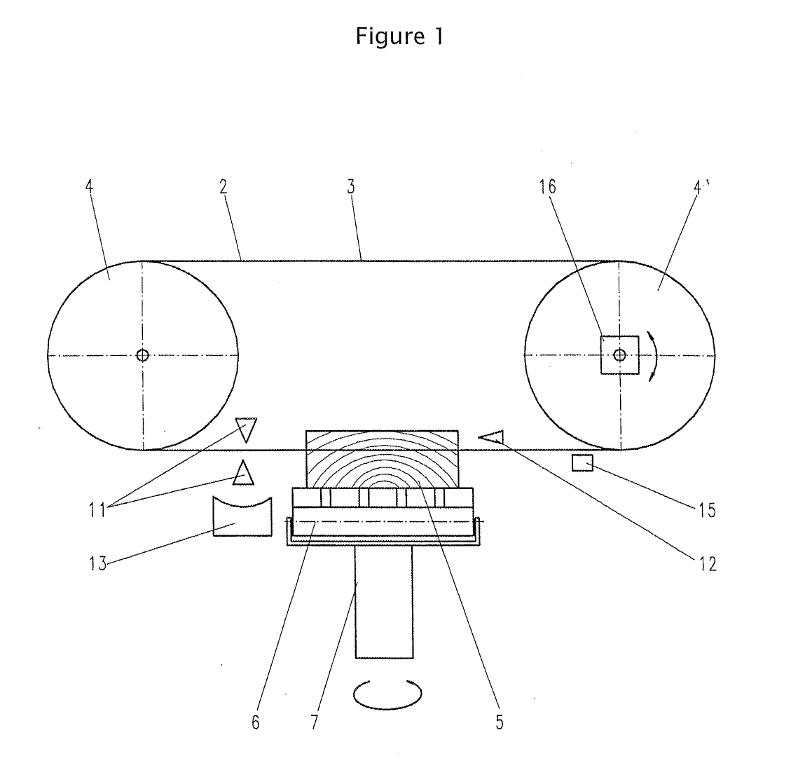

FIG. 1 an apparatus for cutting of materials in an overview representation,

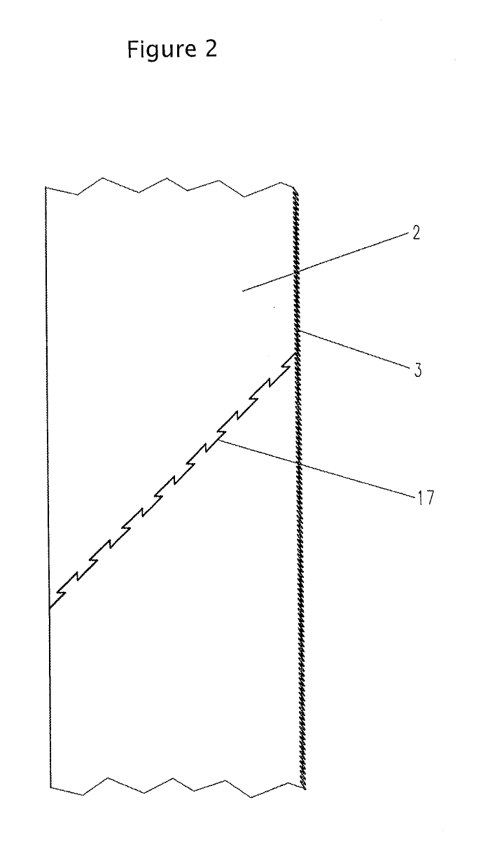

FIG. 2 a saw blade of the apparatus according to FIG. 1, in a detail view,

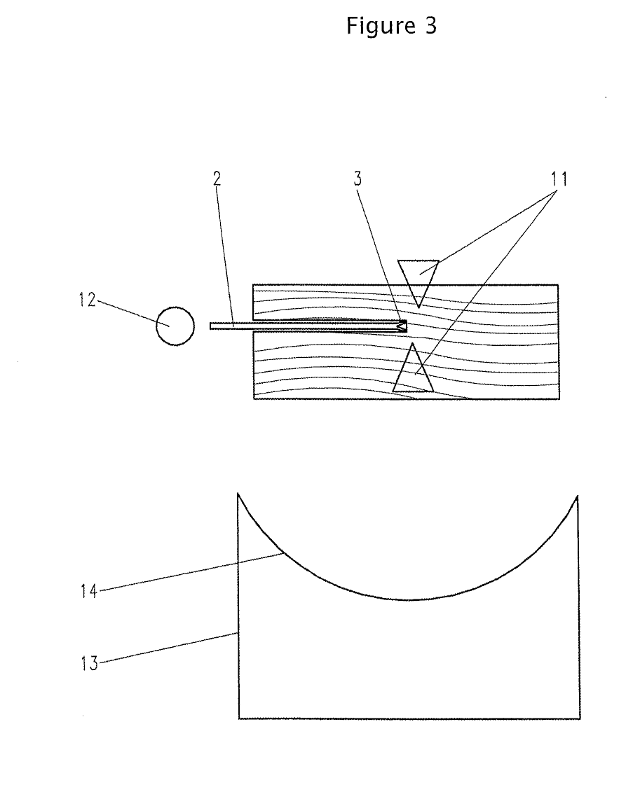

FIG. 3 a blowing apparatus of the apparatus according to

FIG. 1, in a detail view,

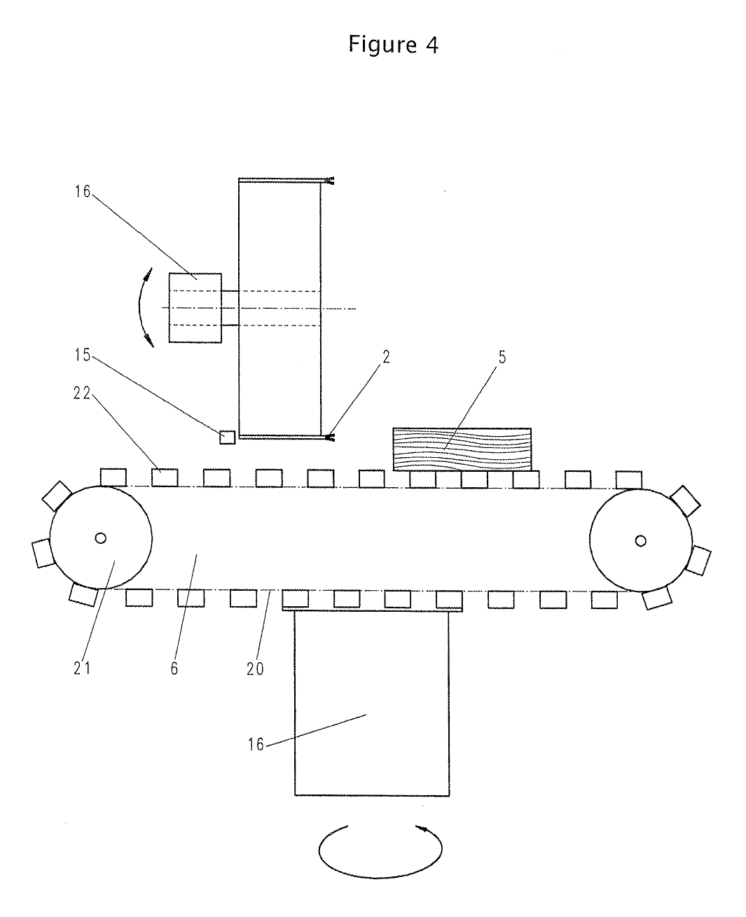

FIG. 4 the material feed of the apparatus according to FIG. 1, in a detail view,

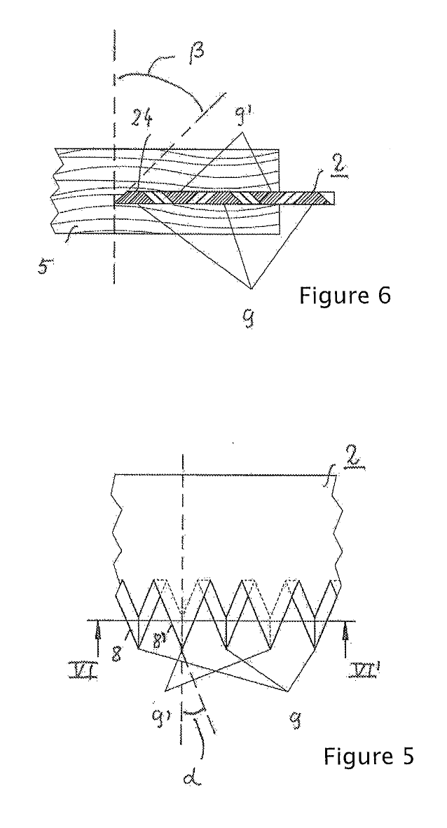

FIG. 5 a detail of the saw blade, in a side view, and

FIG. 6 a sectional view, indicated in FIG. 5 with VI, VI′, supplemented by the relative position in the cut material.

The representation in FIG. 1 shows an apparatus for cutting of materials 1 in a structure that appears conventional at first glance. A grinding saw blade 2 having a micro-tooth system 3 is guided by way of two band saw rollers 4, 4′ that are disposed spaced apart from one another, whereby one of the two band saw rollers 4, 4′ is configured as a drive roller. This band saw roller 4 or 4′ is connected to act together with an electric motor drive, by way of a drive shaft, in a manner that is of no further interest here.

Work pieces 5, wood work pieces in the present example, can be fed to the belt saw, by means of a belt conveyor 6. In this connection, a pivot apparatus 7 is assigned to the belt conveyor 6, in order to adjust the inclination angle of the charging belt 10 and thereby the entry angle of the micro-tooth system 3 into the work piece 5 to be cut.

Furthermore, it can be seen from the overview representation according to FIG. 1 that a first blowing apparatus 11 is disposed in the region of the intended exit of the micro-tooth system 3 from the saw kerf of the work piece 5 to be processed, with which apparatus a water/air mixture can be applied, at high pressure, to the saw blade 2 exiting from the work piece 5, particularly to its micro-tooth system 3, in order to free the latter from adhering wood chips. In addition, a second blowing apparatus 12 is also disposed in the region of the saw blade back of the saw blade 2, with which a water/air mixture can also be pressed, at high pressure, into the saw kerf of the work piece 5 to be processed, which has just been produced, in order to free the saw kerf of wood chips and sawdust.

Furthermore, a collection apparatus 13 for the water/saw meal and sawdust mixture exiting from the saw kerf and blown off from the micro-tooth system 3 is disposed in this region. In this connection, a filter apparatus for pre-cleaning of the mixture follows the collection apparatus 13 in the flow-off direction of the collected mixture.

As is also evident from the overview representation, one of the band saw rollers 4, 4′ has an optical sensor 15 assigned to it, with which the relative position of the circulating grinding saw blade 2 with regard to the band saw roller 4, 4′, in each instance, can be monitored. The measurement result of the sensor 15 is transmitted to a regulation and control unit that is not shown in any further detail in the overview representation, which unit in turn is connected with an angle adjustment apparatus 16, by way of which the inclination of the band saw roller 4, 4′ can be adjusted as a function of an actual value/reference value comparison.

In an alternative embodiment, not shown here, the angle adjustment apparatus 16 can also interact with a roller guide for guiding the grinding saw blade 2, whereby the relative position of the saw blade 2 with regard to the band saw rollers 4, 4′ can also be adjusted by means of pivoting rollers, as a function of an actual value/reference value comparison.

FIG. 2 shows the endless grinding saw blade 2 of the apparatus for cutting of materials 1 in a detail view. According to this detail view, the endless grinding saw blade 2 is provided, in contrast to conventional tooth systems, with a micro-tooth system 3 that is characterized, as compared with the state of the art, in that the micro-teeth have a depth of only 0.5 to 2 mm, in the present exemplary embodiment of approximately 1 mm. Furthermore, the tooth system is structured to be very tight, so that the tooth pitch between the micro-teeth amounts to only 1.5 mm. The usual distance between two teeth generally amounts to between 10 and 25 mm otherwise. Because of the aforementioned low tooth depth and the slight distance between the teeth, the material to be processed is not cut by means of a sawing process, but rather in grinding manner.

This has the advantage of significantly gentler handling of the material, with the result that the cut edges generally do not have to be processed further, i.e. particularly can be glued. Even the branch tear-outs that are otherwise usual during the sawing process can be avoided here, because the branch surface is cut when using the cutting method that is almost like grinding, and remains in the work piece 5 to be cut, without other damage.

The basic blade thickness of the grinding saw blade 2 lies at only 0.3 mm, depending on the desired cut depth, forward movement speed, and wood hardness, instead of the 0.7 to 1.4 mm that is usual otherwise. Accordingly, the projection of the blades relative to the grinding saw blade 2 is also only 1/10 mm. Otherwise, the projection is usually 3/10 to 5/10 mm.

The consequence of these dimensions is an extremely thin saw kerf. The minimal saw kerf width in the case of the novel type of cutting method amounts to only 0.4 mm, while the minimal saw kerf known from the state of the art was 1.4 mm until now. This represents a significant contribution to savings, because the material loss is correspondingly reduced. A further advantage of the gentle cutting of materials described above consists in that in this manner, even thin work pieces 5 can be worked. Thus, it is possible to process thin lamellae from a thickness of 0.2 mm using the novel type of method. In the previous state of the art, only lamellae from a thickness of 2 mm could be processed, whereby the cutting tolerances lay in a range of 0.1 to 0.2 mm. With the novel type of method, cutting tolerances in the range of 0.02 mm are achieved. In the end result, lamella having the thickness of veneer can therefore also be processed, in contrast to the state of the art.

However, the novel type of grinding sawing blade 2 requires a different production process. Because of the low basic blade thickness of only 0.3 mm that has already been mentioned, the face edges of the grinding saw blades can no longer be simply butt-welded to produce an endless band. Such a weld seam would not withstand the chipping forces that occur during the cutting process.

The novel type of saw blade according to FIG. 2 is therefore first joined together by means of a shape-fit tooth system, in the present example a swallowtail tooth system 17, and subsequently this connection is welded using a laser, in material-fit manner. Of course, other shape-fit tooth systems are also possible for joining together the face sides of the grinding saw blades 2. The connection described above is clearly more able to withstand stress than the previously known weld connections of saw blade ends. In the case of the laser welding method used, it must furthermore be noted that if possible, any application of material in the connection region is avoided, to a great extent, because corresponding projections would otherwise have an effect on the cut surface of the work piece 5 to be cut.

Furthermore, the micro-tooth system 3 differs from the previously known usual tooth system not only in the dimensions, but also in the approach angle of the cutting surface with reference to the material surface to be processed. In the sawing processing that was known until now, the cutting surfaces impacted the material to be cut at least approximately at a 90° angle, while the micro-tooth system 3 impacts the material surface at a cutting angle of at least approximately 45°.

In a further detail view, the exit region of the endless grinding saw blade 2 from the saw kerf of the work piece 5 to be processed is shown in FIG. 3. A first blowing apparatus 11 is assigned to this exit region, with which apparatus a water/air mixture is applied to the endless grinding saw blade 2, particularly to the micro-tooth system 3, at correspondingly high pressure, in order to remove the chipped-up cut material from it, which material particularly adheres in the region of the tooth base that lies between the tooth tips. The saw meal residues that remain in the tooth system would otherwise lead to immediate heating during further cutting processes, and, if this happens, also to destruction of the teeth of the micro-tooth system 3. Blade cleaning is clearly less critical in the case of conventional saw blades, because the tooth base that lies between the teeth is clearly larger, as has already been mentioned, and therefore can be cleaned more easily, and also less material adheres in this region. For this reason, it is sufficient, within the state of the art, to vacuum the wall saws clean.

Furthermore, it has proven itself if a further blowing apparatus 12 is disposed in the region of the saw blade back, which also blows a water/air mixture into the saw kerf at high pressure, in order to remove the remaining sawdust of the work piece 5.

The water/dust mixture formed as the result of the blade cleaning and cut surface cleaning described is collected by means of a collection apparatus 13 assigned to this region, and drained into the sewer system, whereby a filter element follows the collection apparatus 13 in the outflow direction, in order to clean the water. Ideally, the cleaned water can be passed back to the cleaning process again, while the collected saw meal mixture is disposed of or processed further. In this method, vacuuming of the band saw as known from the state of the art can be eliminated entirely. The novel type of method of band cleaning has the advantage that the machine room remains clean otherwise, in contrast to the vacuuming method, and does not have to be cleaned at regular intervals. Furthermore, the cut material that is produced is also cleaned better than was known from the state of the art.

In a further detail view, FIG. 4 shows the material feed to the saw apparatus. In this connection, the material is fed to the saw blade 2 by way of a belt conveyor 6, which is a conventional conveyor at first. Conveyor rollers 21 driven by an electric motor provide for forward movement of the conveyor belt 20. From the state of the art, it is known to guide the work piece 5 by means of corresponding guide elements, at least in the region of the grinding saw blade 2, during the cutting process. In contrast to this, vacuum nozzles 22 are assigned to the conveyor belt 20, at least in the region of the grinding saw blade 2, by way of which nozzles the work piece 5 is drawn in and fixed in place by means of a partial vacuum. The advantage of vacuum fixation consists in that any uneven areas and warping of the work piece 5 are evened out by the suction, in that the work piece 5 is drawn in to be flat. The use of vacuum nozzles 22 has particularly proven itself in connection with particularly thin work pieces 5, for example in veneer processing.

As is also evident from the detail view in FIG. 4, an angle adjustment apparatus 16 is additionally assigned to the conveyor belt 20, whereby additional angle adjustment apparatuses 16 can be disposed analogously over the course of the conveyor belt 20. By means of the angle adjustment apparatuses 16, the conveyor belt 20 can be infinitely adjusted in its inclination, in order to thereby vary the entry angle of the micro-tooth system 3 into the conveyor belt 20. Usually, the entry angle can be varied in a range between 60° to 90°, by means of corresponding pivoting of the conveyor belt 20. The more obtuse entry angle reduces the stress on the grinding saw blade 2 and thereby improves the precision of the cut guidance.

Furthermore, a reverse movement stop is assigned to the conveyor belt 20. Because of the extremely close-meshed tooth system, reverse movement of only a few millimeters could already damage the mini-teeth that are used.

FIG. 5 shows the grinding saw blade 2 in a side view, in a detail view, from which it is at first evident that the micro-teeth 8, 8′ of the micro-tooth system 3, which follow one another in the cutting direction, are configured at a slant relative to one another. The grinding saw blade 2 is therefore an offset saw blade. Furthermore, the cutting sides of the micro-teeth 8, 8′ that follow one another alternate, so that the micro-teeth 8, for one thing, engage on the one side of a saw kerf 24, and the subsequent other micro-teeth 8′ engage on the other side of the same saw kerf 24, as is evident from the sectional view according to FIG. 6. For a better understanding, this sectional view shows the engagement of the grinding saw blade (2) into the work piece 5 to be processed, in a sectional top view.

As is also evident from FIG. 5, the micro-tooth system attacks the surface of the material to be cut at a chipping angle α that lies between 5° and 30°. In this connection, the chipping angle is impressed between the surface of the cutting surface of the micro-tooth 8, 8′, in each instance, and a normal line relative to the surface of the adjacent saw kerf 24. The chipping angle α is illustrated in FIG. 5 by broken auxiliary lines. This is an angle that leads the normal line in the cutting direction, while the chipping angle trails this normal line in the case of a conventional tooth system, and accordingly turns out to be comparatively obtuse, between 6° and 15°.

In the sectional view according to FIG. 6, in contrast, the cutting angle β is drawn between two broken auxiliary lines, whereby the cutting angle β is the angle that the micro-teeth 8, 8′ have in the sectional view according to FIG. 6, relative to the saw kerf edge, in the cutting direction. The cutting angle in the case of a conventional tooth system usually lies mostly at 90°. In the case of the tooth system according to the invention, it lies between 40° and 60°, as is also shown in FIG. 6.

Above, a novel type of apparatus for cutting of materials 1, particularly of wood work pieces 5, has therefore been described, which is characterized, as compared with the state of the art, in that in place of the chipping sawing method known until now, a gentle grinding sawing method is used. The novel type of method makes extremely thin saw kerfs possible, by means of the use of a special micro-tooth system 3 and a novel type of grinding saw blade 2 with a clearly reduced thickness, which kerfs can be produced with great precision, so that in this way, the loss of the material used is significantly reduced. Furthermore, the gentler material processing allows handling of work pieces 5 having a low thickness, down to processing of veneer. However, the advantages described require a novel type of production of the saw blade 2 used, a novel type of band cleaning, and high-quality blade guidance, in order to prevent the micro-tooth system 3, which is clearly more sensitive, from destruction caused by running up onto the band saw rollers 4, 4′ or caused by a possible reverse movement of the saw blade.

### REFERENCE SYMBOL LIST

1 apparatus for cutting of materials
2 grinding saw blade
3 micro-tooth system
4, 4′ band saw rollers
5 work piece
6 belt conveyor
7 pivot apparatus
8, 8′ micro-teeth
9, 9′ cutting edge of the micro-teeth
10 charging belt
11 first blowing apparatus
12 second blowing apparatus
13 collection apparatus
14 filter
15 sensor
16 angle adjustment apparatus
17 swallowtail tooth system
20 conveyor belt
21 conveyor roller
22 vacuum nozzles
23 reverse movement stop
24 saw kerf
α chipping angle
β cutting angle

1. Apparatus for cutting of materials, producing a thin saw kerf, wherein a preferably endless grinding saw blade (2) having a micro-tooth system (3) is used for cutting of materials, particularly of wood, wherein the micro-teeth (8, 8′) of the micro-tooth system (3) are provided with a cutting surface, in each instance, wherein the micro-teeth (8, 8′) of the micro-tooth system (3), which follow one another in the cutting direction, in each instance, are ground in such a manner that one blade (9) is disposed on the right and one blade (9′) is disposed on the left, in each instance, alternately one after the other, so that the saw kerf (24) is worked on by the micro-teeth (8, 8′) alternately at the right and left cut edge, in each instance, wherein the micro-tooth system (3) of the grinding saw blade (2) is provided with micro-teeth (8, 8′), the tooth pitch of which amounts to 0.5 to 2 mm, and the tooth height, defined by the tooth base that lies between the micro-teeth (8, 8′), amounts to ≦1.5 mm.

2. Apparatus according to claim 1, wherein the grinding saw blade (2) is configured to be offset in such a manner that in the cutting direction of the grinding saw blade (2), micro-teeth (8, 8′) of the micro-tooth system (3) are disposed at a slant relative to one another, in such a manner that the micro-teeth (8, 8′) project alternately to the right and the left beyond the grinding saw blade (2).

3. (canceled)

4. Apparatus according to claim 1, wherein the micro-teeth (8, 8′) of the micro-tooth system (3) are set, with regard to the grinding saw blade (2), in such a manner that in the operating state, an obtuse cutting angle (1) of preferably 40° to 60° relative to the surface of the material to be cut is set.

5. Apparatus according to claim 1, wherein the projection of the tooth blades (9, 9′) of the micro-tooth system (3) relative to the grinding saw blade (2) amounts to only a few tenths of millimeters, preferably 1/10 mm.

6. Apparatus according to claim 1, wherein the saw blade thickness amounts to between 0.1 and 0.5 mm.

7. Apparatus according to claim 6, wherein the saw blade ends are connected with one another, on the face side, by means of a tooth system, preferably by means of a swallowtail tooth system (17), and preferably connected with material fit by means of a laser weld seam.

8. Apparatus according to claim 1, wherein in the intended installation state, a blowing apparatus (11) is assigned to the exit of the micro-tooth system (3) from the saw kerf (24) of the material to be cut, in such a manner that the micro-tooth system (3) is impacted by means of a water/air mixture.

9. Apparatus according to claim 8, wherein a further blowing apparatus (12) is assigned to the saw blade back of the grinding saw blade (2), in such a manner that a water/air mixture can be pressed into the saw kerf (24) of the material to be cut, preferably at high pressure.

10. Apparatus according to claim 8, wherein the blowing apparatuses (11, 12) have a common control unit and/or a supply unit and pump unit for charging them with the water/air mixture assigned to them.

11. Apparatus according to claim 8, wherein a collection apparatus (13) for collecting a water/saw meal mixture is disposed in the blow-off direction of the water/air mixture applied by means of the blowing apparatus(es) (11, 12), wherein a filter element follows this collection apparatus (13).

12. Apparatus according to claim 1, wherein a belt conveyor or chain conveyor for supplying the material to be cut is assigned to the saw mill comprising the grinding saw blade (2) having the micro-tooth system (3), wherein the belt or chain conveyor is additionally provided with vacuum nozzles (22), in such a manner that the work piece (5) to be processed can be fixed in place by means of a partial vacuum, and subsequently can be moved relative to the saw blade (2) by means of the belt or chain conveyor.

13. Apparatus according to claim 12, wherein the roller or chain conveyor has a charging belt (10), in each instance, for transport of the material to be cut, wherein a pivot mechanism for adjusting the inclination angle of the charging belt (10) is assigned to this charging belt (10), in such a manner that the entry angle of the micro-tooth system (3) into the work piece (5) to be processed is infinitely adjustable in a range of 60° to 90°.

14. Apparatus according to claim 1, wherein the grinding saw blade (2) is guided by means of two band saw rollers (4, 4′) that are disposed spaced apart from one another.

15. Apparatus according to claim 14, wherein a sensor (15) for detecting the relative position of the band saw with regard to the band saw roller (4, 4′), in each instance, is assigned to at least one band saw roller (4, 4′), and wherein the inclination of at least one band saw roller (4, 4′) can be automatically regulated by way of an angle adjustment apparatus (16), as determined by an actual value/reference value comparison.

16. Apparatus according to claim 1, wherein the circulating grinding saw blade (2) driven by means of the band saw rollers (4, 4′) has a forward movement monitoring apparatus and/or a reverse movement stop (23) assigned to it.

17. Apparatus according to claim 1, wherein the grinding saw blade (2) is vertically clamped in a saw frame, to establish a saw gate.
